(19) United States
(12) Patent Application Publication
(10) Pub. No.: US 2011/0227244 A1
(43) Pub. Date: Sep. 22, 2011

(54) MOLDED FIBER LID FOR A CONTAINER

(76) Inventors: Eric R. BROWN, Benton, ME (US); Donald Victor BRETON, North Vassalboro, ME (US)

(21) Appl. No.: 13/084,140

(22) Filed: Apr. 11, 2011

Related U.S. Application Data
(63) Continuation of application No. 11/086,895, filed on Mar. 22, 2005.
Application No. 11/086,895 is a continuation of application No. 12/562,325, filed on Sep. 18, 2009.

(51) Int. Cl. B29C 41/50

(52) U.S. Cl. 264/101

(57) ABSTRACT

A container lid formed of cellulose material is provided for mating with a base container to securely hold various items, such as food items. The container lid includes a body having a main portion and a perimeter, and a skirt extending substantially around the perimeter of the body. The skirt includes a shoulder and an intermediate member connected with the shoulder. The intermediate member extends inwardly towards the base container when mating therewith. The intermediate member and skirt cooperatively form a channel or undercut for receiving the base container so that the base container and lid may be interlocked together.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Disposable containers have been used for decades by restaurants and other food establishments to deliver food items to customers. These containers are typically made from either paper products or synthetic materials such as polyethylene or polystyrene. Scientists have discovered, however, that the manufacture of certain synthetic materials can have an adverse impact on the environment. For example, it is believed that the chlorofluorocarbons (CFCs) often used in producing polystyrene foam packaging may harm the Earth's ozone layer. Furthermore, there is increased environmental awareness regarding recycling of materials, and more and more disposable containers and associated packaging are manufactured from recycled paper and other post-consumer product (e.g., recycled polyethylene).

With respect to disposable food containers, manufacturers are moving towards using natural fibers, such as virgin and/or recycled paper pulp, as a raw material for certain applications. Containers made from natural fibers are able to absorb a certain amount of moisture from the food items placed therein, thereby reducing the tendency for the items to become soggy. Another advantage of natural fiber containers is that they possess good insulative properties. There is also an ample supply of post-consumer paper that is available to the container manufacturers, so that use of such paper reduces the amount of materials that must be disposed of in landfills.

The most common method of manufacturing fiber containers and components is by molding an article between a pair of dies using heat, and optionally, vacuum pressure. This process works relatively well for articles of simple geometries. However, when certain more complex geometric features are required (e.g., multi-stage curve), conventional molding methods have produced unsatisfactory results. Consistent article quality in fiber molding is also often elusive due to moisture present in the raw material used in the molding process. Thus, molded fiber containers and components have not achieved as widespread a use as would be possible if improved molding techniques were available.

### BRIEF SUMMARY OF THE INVENTION

An improved molded fiber container lid and method of manufacture thereof may be implemented to provide, with a base container, a food holding solution. In one aspect, the molded fiber lid formed of cellulose material includes a body and a skirt. The body has a main portion and a perimeter, and may take on a variety of shapes (e.g., elliptical and others). The skirt extends at least substantially around the perimeter of the body, and has an inside surface into which an undercut is formed. The undercut defines a lateral dimension extending from a first portion of the undercut to a second portion of the undercut directly opposite and across the skirt from the first portion. This lateral dimension of the skirt in the undercut region is greater than a second lateral dimension defined as extending between portions of the skirt immediately above the first and second portions of the undercut and greater than a third lateral dimension defined as extending between portions of the skirt immediately below the first and second portions of the undercut. This provides the skirt with an interlocking feature that releasably secures a peripheral portion of a base container within the undercut.

In another aspect, a molded fiber container lid formed of cellulose material is configured to mate with a base container. The lid includes a body and a skirt, the body having a main portion and a perimeter, and the skirt extending at least substantially around the perimeter of the body. The skirt includes a shoulder and an intermediate member connected with the shoulder. The intermediate member extends inwardly towards the base container when mating therewith. The intermediate member and skirt cooperatively form a channel for receiving the base container so that the base container and lid may be interlocked together.

A process for drying and shaping a material lay up to form a molded fiber container lid is also provided. As a first step, a vacuum die base has an article molding region that is overlaid with a vacuum wire. A vacuum die ring is then supplied, and may be placed over one or more of the vacuum die base and a perimeter region of the vacuum wire. The vacuum die ring is formed with an undercut. The material lay up to be molded into the fiber lid, preferably a cellulose material, is then placed onto the vacuum wire and the vacuum die ring. A finishing die is then placed upon the material lay up to press the material against the vacuum wire and against the vacuum die ring and into the undercut. Heat is then applied and a vacuum is drawn on the material lay up through the vacuum wire for a time sufficient to mold and dry the material into the finished fiber lid. Other features and aspects of the invention will appear in the course of the following description.

### BRIEF DESCRIPTION OF THE SEVERAL VIEWS OF THE DRAWING

In the accompanying drawings which form a part of the specification and are to be read in conjunction therewith and in which like reference numerals are used to indicated like elements in the various views:

FIG. 1 is a perspective view of a molded fiber lid in accordance with one embodiment of the present invention;

FIG. 2 is a front elevational view of the molded fiber lid of FIG. 1 shown in a mating relationship with a base container;

FIG. 3 is a cross-sectional view of the mating fiber lid and base container of FIG. 2 taken along line 3-3;

FIG. 4 is a fragmentary sectional view on an enlarged scale of the mating fiber lid and base container of FIG. 2;

FIG. 5 is an exploded view of the sectioned fiber lid and base container of FIG. 3; and

FIG. 6 is a fragmentary sectional view showing a molding tool that may be implemented to form the molded fiber lid of FIG. 1.

### DETAILED DESCRIPTION OF THE INVENTION

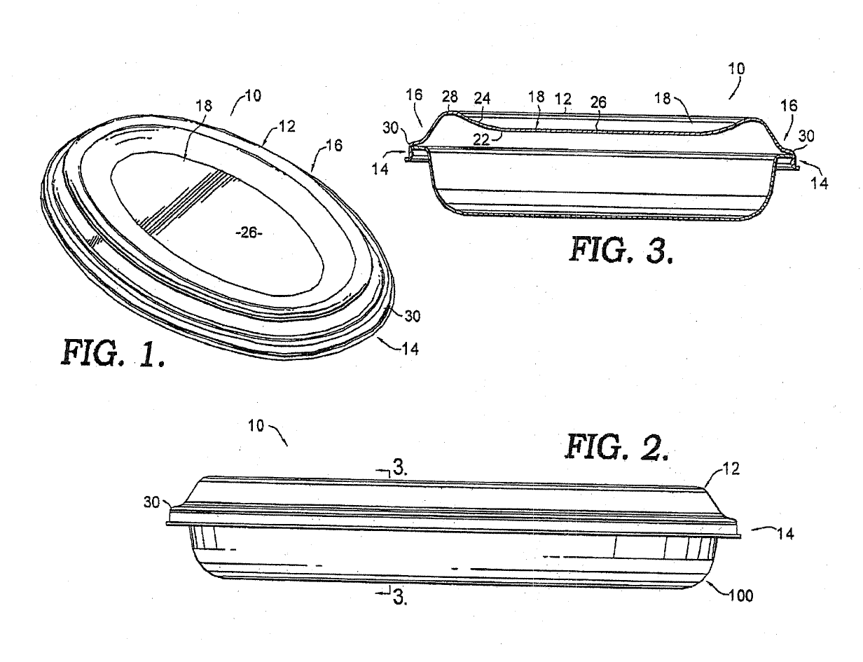

Turning now to the drawings, and initially to FIG. 1, there is shown a molded fiber container lid 10 of the present invention. The container lid 10 generally comprises a body 12 and a skirt 14 extending around a perimeter 16 of the body 12. The body 12 has a main portion 18 generally defining a central region of the container lid 10 and which is bounded by the perimeter 16. The container lid 10 may be manufactured from various materials, and includes as a majority or whole content, cellulose material. One preferred cellulose material is recycled paper fiber, but other materials, such as non-recycled paper and others, may be utilized as well. Paper fiber, recycled and non-recycled, lends itself well to use in certain molding processes to form container lid articles, as will be more fully explained herein. As can be seen, the container lid 10 may be formed as a single part monolithic structure.

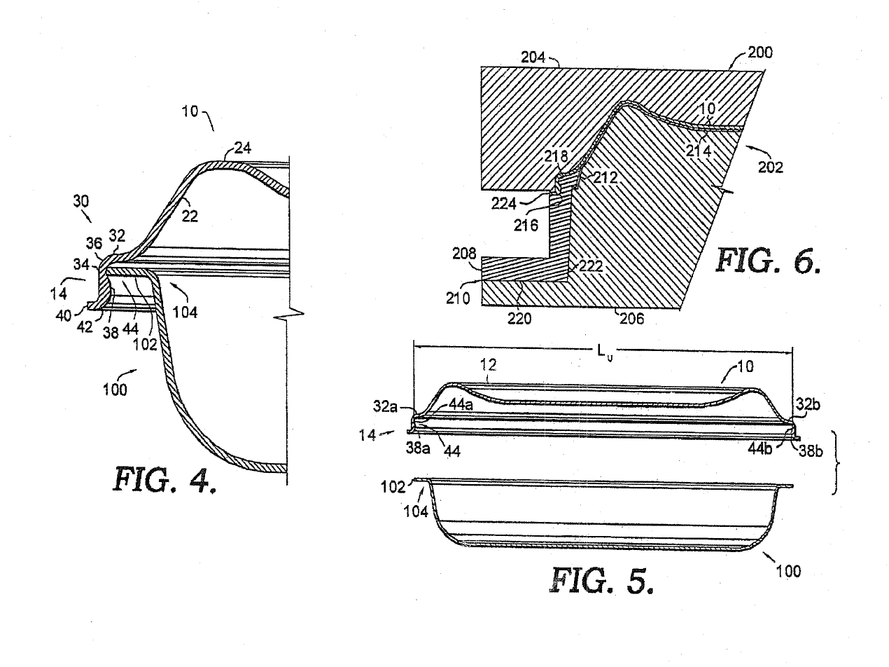

Further details of the structure of the container lid 10 and how the lid 10 matingly receives a base container 100 may be observed with reference to FIGS. 2-4. The skirt 14 and body 12 of the container lid 10 together defining an inside surface 22 and an outside surface 24 for the container lid 10, with the inside surface 22 generally facing towards the base container 100 when mated with the lid 10. It should be understood that the shape of the main portion 18 of the body 12 shown—including a planar center section 26 and a circumferential ridge 28—is exemplary, and other shapes may be selected as a matter of design choice. A shoulder 30 of the skirt 14 has an upper portion 32 extending generally radially outward from the perimeter 16 of the body 12 and a lower portion 34 extending downwardly from the upper portion 32 at a curved transition 36. The skirt 14 also has an intermediate member 38 continuing from the lower portion 34 of the shoulder 24. The intermediate member 38 extends inwardly towards the base container 100 on the inside surface 22 of the container lid 10 when the container lid 10 is in mating reception with the base container 100, as is best seen in FIGS. 3 and 4. To provide a surface that may be grasped to aid in separation of the container lid 10 from the base container 100, an end flange 40 may extend outwardly from a curved transition 42 of the intermediate member 38.

The mating reception between the container lid 10 and the base container 100 is facilitated by an interlocking feature formed on the lid. More specifically, an undercut 44 defined as a region between the shoulder 30 and the intermediate member 38 on the inside surface 22 of the container lid 10 preferably forms a continuous channel extending around the skirt 14. The undercut 44 receives a cantilevered flange 102 or other rim element extending outwardly from a peripheral portion 104 of the base container 100 for interlocking therewith. It can be seen from FIGS. 3 and 4, and with reference to FIGS. 1 and 2, that at least the inside surface 22 of the container lid 10 along the undercut 44, as well as the cantilevered flange 102 of the base container 100, take on the profile of an ellipse in the lateral plane when viewed from above or below the lid 10 and base container 100; however, it should be understood that other shapes may be selected for these features, such as circular, oblong elliptical, rectangular or other polygonal shape.

A lateral dimension L_{U} across the inside surface 22 of the container lid 10 at the point of the undercut 44 may be measured from a first portion 44a of the undercut to a second portion 44b of the undercut directly opposite and across the skirt 14 from the first portion 44a, as depicted in FIG. 5. Lateral dimension L_{U} is greater than lateral dimensions across the container lid 10 from similar points immediately above and below the undercut first and second portions 44a, 44b on the skirt 14 (i.e., from a first portion 32a to a second portion 32b of the shoulder upper portion 32, and from a first portion 38a to a second portion 38b of the intermediate member 38). As such, the undercut 44 works with the shoulder 30 and intermediate member 38 of the skirt 14 to maintain the cantilevered flange 102 of the base container 100 within the undercut 44 in an interlocking relationship, as illustrated in FIG. 4.

FIG. 5 further shows the container lid 10 separated from the base container 100. It can be seen that interlocking between the container lid 10 and base container 100 depends on the lateral dimension of the container 100 at the terminal edge of the cantilevered flange 102 (when the container 100 and lid 10 are properly aligned for mating). Such a container 100 lateral dimension should be greater than the lateral dimension of the container lid inside surface 22 between the first and second portions 38a, 38b of the intermediate member, but generally about or less than the lateral dimension L_{U} at the undercut 44, to accomplish the interlocking seen in FIGS. 3 and 4. As the container lid 10 is pushed down upon the base container 100, the intermediate member 38 around the skirt 14 will press against the cantilevered flange 102 (or other rim element of the base container if provided) around the container peripheral portion 104. Either or both of the cantilevered flange 102 and the skirt 14 are configured to have sufficient flexibility as to deflect and allow the flange 102 to slide pass the interference with the intermediate member 38 of the skirt 14 and into the undercut 44 to lock the lid 10 with the base container 100. When it is desired to remove the lid 10, the end flange 40 and/or the curved transition 42 of the intermediate member 38 may be pulled outward and upward so that the intermediate member 38 and cantilevered flange 102 have sufficient clearance as to slide past one another.

One process for manufacture of the container lid 10 involves the use of a molding tool 200 as shown in FIG. 6. Closed molding techniques are preferably implemented to form the container lid 10. Molding tool 200 includes a vacuum die assembly 202 and a finish die 204. Although shown only in section, the molding tool 200 is sized and configured to dry and mold a complete article such as the container lid 10 of FIG. 1 by drying and shaping a material lay up. Also, the vacuum die assembly 202 and finish die 204 may be formed out of various metals, as those of skill in the art will appreciate with respect to typical molding tool 200 components.

The vacuum die assembly 202 may include a vacuum die base 206 supporting the rest of the components of the assembly 202, a vacuum die ring 208 mating with the base vacuum die 206 around the periphery 210 thereof, and a vacuum wire 212 positioned atop and mating with an article molding region 214 of the vacuum die base 206. Preferably, the base vacuum die 206 is perforated and the vacuum wire 212 is a mesh screen allowing moisture present in the raw material lay up to be molded (as one example, up to 100% recycled paper as raw material) to escape through the vacuum wire 212 and base 206 perforations to fully cure the final container lid article 10. The vacuum die ring 208 and the finish die 204 may have solid surfaces. To form the undercut 44 in the container lid article 10, the vacuum die ring 208 has a channel 216 into which raw material to be molded may enter. A shoulder 218 is also formed on the vacuum die ring 208 above the channel 216, with the shoulder 218 having generally a convex profile to contrast with the generally concave profile of the channel 216. The portion of the article 10 that forms in the channel 216 becomes at least a section of the intermediate member 38, and the portion of the article 10 thereabove that forms around the shoulder 218, i.e., the shoulder 30 and the interface between the shoulder 30 and the intermediate member 38, defines, along with the intermediate member 38 section formed in the channel 216, the undercut 44. In one example of production of one embodiment of the container lid 10, the lay up of cellulose raw material to be formed into the container lid article 10 is about 0.03 inches thick, the vacuum wire 212 is about 0.02 inches thick, and the channel 216 has at least a partially curved profile with a lateral depth of about 0.025 inches.

The molding process begins with placing the vacuum wire 212 on the top surface 214 of the vacuum die base 206. The vacuum die ring 208 is placed on a lower shelf 220 of the base 206 and is positioned to abut a perimeter sidewall 222 of the base 206 and cover a perimeter region of the vacuum wire 212. In this position, the vacuum die ring 208 aids in maintaining the wire 212 firmly against the base 206. One option for the process is to then apply the raw material lay up that will be molded into the container lid article 10 onto the vacuum wire 212 and the vacuum die ring 208, and subsequently place the finish die 204 atop the lay up. Alternatively, the finish die 204 may be placed atop the vacuum die assembly 202 such that a gap is formed therebetween, and the raw material then injected into the gap. Preferably, if injection-type molding techniques are implemented, where material enters the gap between the vacuum die assembly 202 and the finish die 204 under pressure, the vacuum die ring 208 will extend to cover the lateral perimeter 224 of the gap to keep the raw material being molded from exiting out of the molding tool 200. The finish die 204 forces the raw material lay up into the channel 216 to form the intermediate member 38 that, along with shoulder 30, defines the undercut 44. Heat is preferably applied to the raw material lay up through at least the vacuum die ring 208 and the finish die 204. Along with application of heat, a vacuum draw is preferably applied to the raw material lay up through the vacuum wire 212 to force the raw material lay up to closely conform to the shape defined by the wire 212 and the vacuum die ring 208. The combination of the vacuum draw and heat serve to fully cure the lay up and force excess moisture out through the vacuum wire 212 and base 206 perforations. Upon curing, the finish die 204 may be removed to reveal the fully molded container lid 10. Due to the vacuum die ring shoulder 218, the container lid 10 must be pried off of the die ring 208 to be released from the molding tool 200. Those of skill in the art will appreciate that the amount and timing of heat application, as well as the extent of vacuum draw applied to the raw material lay up by the molding tool 200, depend on the particular raw materials chosen to form the container lid 10.

Thus, the molded fiber container lid 10 of the present invention provides a simple and easy to use solution for securely and releasably covering various base containers, particularly for food holding containers. In another embodiment of the container lid 10, the skirt 14 may extend substantially, though not all the way around, the body perimeter 16; one example of which would be if a tab (not shown) extends outwardly from the cantilevered flange 102 of the base container 100 and the body 12 of the fiber lid 10 ends abruptly at the tab. Such a tab could be grasped by a user to hold the base container 100 steady while the fiber lid 10 is pulled out of the interlocking relationship therewith. In yet another variation of the container lid 10 and base container 100 design, the positions of the undercut 44 and the cantilevered flange 102 may be reversed. In other words, the undercut 44 could be formed on the lid outside surface 24 between the curved transition 36 of the shoulder 30 and the end flange 40, instead of on the lid inside surface 22, and the cantilevered flange 102 could extend laterally inwardly from the base container peripheral portion 104 instead of outwardly therefrom. Such a configuration allows the cantilevered flange 102 to slip past the end flange 40 on the lid outside surface 24 and into the undercut 44 now formed on the outside surface 24 to provide the interlocking relationship between the container lid 10 and the base container 100.

Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1-20. (canceled)

21. A method of making a container lid, said method comprising the steps of:
providing a vacuum die base with an article molding region;
overlying the article molding region of the vacuum die base with a vacuum wire;
placing a vacuum die ring against at least one of the vacuum die base and the vacuum wire, the vacuum die ring including a channel formed thereon;
placing a cellulose material lay up to be molded into an article on the vacuum wire and the vacuum die ring; and
overlying the cellulose material lay up with a finishing die to press the cellulose material lay up against the vacuum wire and against the vacuum die ring and into the channel;
applying heat to the cellulose material lay up with at least one of the finishing die and the vacuum die ring;
wherein the vacuum die ring facilitates the formation of the cellulose material lay up as a container lid having an undercut.

22. The method of claim 21, further comprising drawing a vacuum on the cellulose material lay up through the vacuum wire.

23. The method of claim 21, wherein the vacuum wire and the vacuum die base are perforated to allow the vacuum to be drawn on the cellulose material lay up.

24. The method of claim 21, wherein the channel of the vacuum die ring has a concave configuration, and wherein the vacuum die ring further includes a convex shoulder region above the channel.

25. The method of claim 21, wherein the vacuum die ring is placed on a lower shelf of the vacuum die base and is positioned to abut a perimeter sidewall of the vacuum die base and cover a perimeter region of the vacuum wire.

26. The method of claim 21, wherein the channel has at least a partially curved profile with a lateral depth of about 0.025 inches.

27. The method of claim 21, further comprising prying the container lid from the vacuum die ring to release the container lid therefrom.

28. A method of making a container lid, said method comprising the steps of:
providing a vacuum die base with an article molding region;
placing a vacuum die ring against at least one of the vacuum die base and the vacuum wire, the vacuum die ring including a channel formed thereon;
placing a cellulose material lay up to be molded into an article on the article molding region and the vacuum die ring; and
overlying the cellulose material lay up with a finishing die to press the cellulose material lay up against the article molding region and against the vacuum die ring and into the channel;
wherein the vacuum die ring facilitates the formation of the cellulose material lay up as a container lid having an undercut.

29. The method of claim 28, further comprising overlying the article molding region of the vacuum die base with a vacuum wire.

30. The method of claim 29, further comprising drawing a vacuum on the cellulose material lay up through the vacuum wire.

31. The method of claim 29, wherein the vacuum wire and the vacuum die base are perforated to allow the vacuum to be drawn on the cellulose material lay up.

32. The method of claim 29, wherein the vacuum die ring is placed on a lower shelf of the vacuum die base and is positioned to abut a perimeter sidewall of the vacuum die base.

33. The method of claim 32, wherein the vacuum die ring covers a perimeter region of the vacuum wire.

34. The method of claim 28, further comprising applying heat to the cellulose material lay up with at least one of the finishing die and the vacuum die ring.

35. The method of claim 28, wherein the channel of the vacuum die ring has a concave configuration, and wherein the vacuum die ring further includes a convex shoulder region above the channel.

36. The method of claim 28, wherein the channel has at least a partially curved profile with a lateral depth of about 0.025 inches.

37. The method of claim 28, further comprising prying the container lid from the vacuum die ring to release the container lid therefrom.
